(19) United States
(12) Patent Application Publication
(10) Pub. No.: US 2026/0181124 A1
(43) Pub. Date: Jun. 25, 2026

(54) STEREOSCOPIC IMAGE DISPLAY

(71) Applicant: SONY GROUP CORPORATION, TOKYO (JP)

(72) Inventors: ICHIRO MORI, TOKYO (JP); YUTO KOBAYASHI, TOKYO (JP); NORIAKI TAKAHASHI, TOKYO (JP)

(21) Appl. No.: 19/126,626

(22) PCT Filed: Sep. 19, 2023
(86) PCT No.: PCT/JP2023/033838

§ 371 Date: May 1, 2025

(30) Foreign Application Priority Data
Nov. 8, 2022 (JP) 2022-178715

(51) Int. Cl. H04N 13/305

(52) U.S. Cl. CPC H04N 13/305

(57) ABSTRACT

A stereoscopic image display of the disclosure includes a display panel and a parallax barrier. The display panel includes a plurality of pixels and displays a plurality of parallax images forming a stereoscopic image. The parallax barrier is disposed facing the display panel and includes a shielding part having a surface on which a pattern of design is formed and a plurality of openings through which light emitted from the display panel passes. In an environment in which the stereoscopic image is observed, a spatial frequency of the pattern of design is set within a visible range determined based on a contrast sensitivity function.

### TECHNICAL FIELD

The disclosure relates to a stereoscopic image display including a parallax barrier.

### BACKGROUND ART

In general, an existing stereoscopic image display including a parallax barrier displays a stereoscopic (3D) image on a black display surface, which makes some viewers waver where to focus their eyes for stereoscopic viewing and hinders the viewers from recognizing a stereoscopic effect due to convergence. To address this, a display in which a design layer is stacked on a shielding part of a parallax barrier is proposed (PTL 1).

### CITATION LIST

### Patent Literature

PTL 1: Japanese Unexamined Patent Application Publication No. 2020-46472

### SUMMARY OF THE INVENTION

The display described in PTL 1 involves a technique designed to alleviate a sense of discomfort caused by a difference between the position of a display surface of a display panel on which an image is displayed and the position of a surface of the parallax barrier in a depth direction, and not designed to enhance the perception of stereoscopic image representation.

It is desirable to provide a stereoscopic image display that makes it possible to display stereoscopic images with enhanced stereoscopic perception.

A stereoscopic image display according to one embodiment of the disclosure includes a display panel and a parallax barrier. The display panel includes a plurality of pixels and displays a plurality of parallax images forming a stereoscopic image. The parallax barrier is disposed facing the display panel and has a shielding part having a surface on which a pattern of design is formed and a plurality of openings through which light emitted from the display panel passes. In the environment in which the stereoscopic image is observed, a spatial frequency of the pattern of design is set within a visible range determined based on a contrast sensitivity function.

According to the stereoscopic image display according to the embodiment of the disclosure, the spatial frequency of the pattern of design formed on the surface of the parallax barrier is set within the visible range determined based on the contrast sensitivity function in the environment in which the stereoscopic image is observed.

### BRIEF DESCRIPTION OF THE DRAWINGS

FIG. 1 is a configuration diagram illustrating an outline of a display according to a comparative example.

FIG. 2 is a configuration diagram schematically illustrating an example of a stereoscopic image display according to one embodiment of the disclosure.

FIG. 3 is a cross-sectional view illustrating an outline of stereoscopic viewing based on a parallax barrier method provided by the stereoscopic image display according to the embodiment.

FIG. 4 is an explanatory diagram schematically illustrating exemplary configuration conditions regarding a display panel and a parallax barrier of the stereoscopic image display according to the embodiment.

FIG. 5 is an explanatory diagram schematically illustrating exemplary configuration conditions regarding the parallax barrier of the stereoscopic image display according to the embodiment.

FIG. 6 is an explanatory diagram illustrating a contrast sensitivity function.

FIG. 7 is a configuration diagram illustrating an outline of a stereoscopic image display according to Modification Example 1.

FIG. 8 is a flowchart illustrating the outline of the stereoscopic image display according to Modification Example 1.

FIG. 9 is a flowchart illustrating an outline of a stereoscopic image display according to Modification Example 2.

FIG. 10 is an explanatory diagram illustrating the outline of the stereoscopic image display according to Modification Example 2.

FIG. 11 is a flowchart illustrating an outline of a stereoscopic image display according to Modification Example 3.

FIG. 12 is a configuration diagram illustrating the outline of the stereoscopic image display according to Modification Example 3.

FIG. 13 is an explanatory diagram illustrating a first configuration example of a stereoscopic image display according to Modification Example 4.

FIG. 14 is an explanatory diagram illustrating a second configuration example of the stereoscopic image display according to Modification Example 4.

FIG. 15 is a configuration diagram illustrating a third configuration example of the stereoscopic image display according to Modification Example 4.

FIG. 16 is a configuration diagram illustrating an outline of a stereoscopic image display according to Modification Example 5.

FIG. 17 is a flowchart illustrating the outline of the stereoscopic image display according to Modification Example 5.

FIG. 18 is a configuration diagram illustrating an outline of a stereoscopic image display according to Modification Example 6.

FIG. 19 is a flowchart illustrating the outline of the stereoscopic image display according to Modification Example 6.

FIG. 20 is a configuration diagram illustrating an outline of a stereoscopic image display according to Modification Example 7.

FIG. 21 is a flowchart illustrating the outline of the stereoscopic image display according to Modification Example 7.

FIG. 22 is a configuration diagram illustrating an outline of a stereoscopic image display according to Modification Example 8.

### MODES FOR CARRYING OUT THE INVENTION

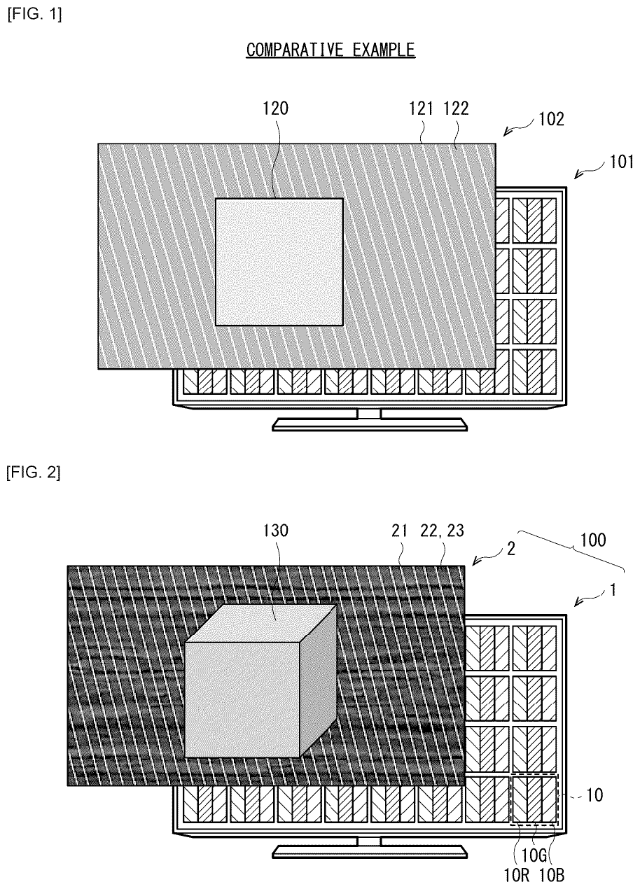

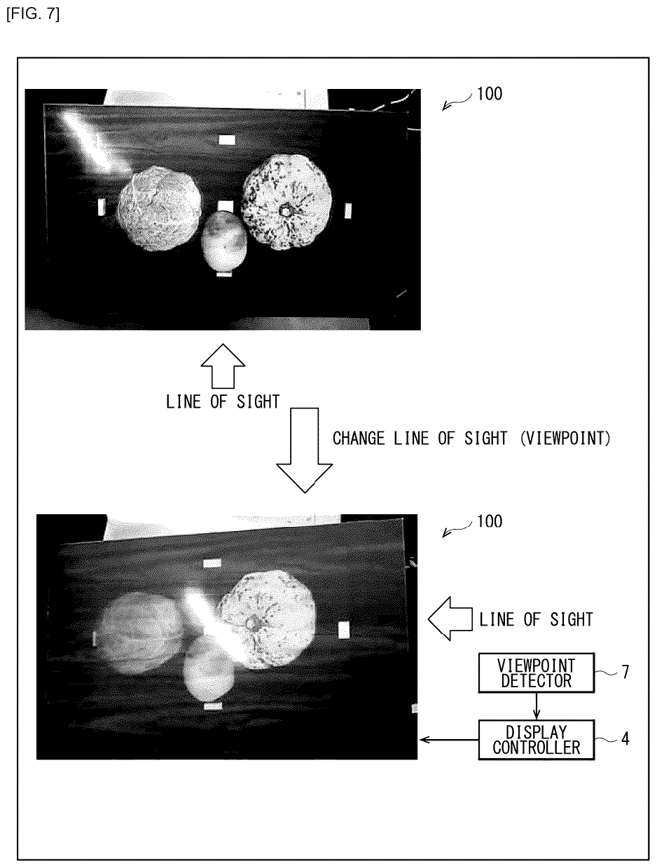

In the following, some embodiments of the disclosure are described in detail with reference to the drawings. It is to be noted that the description is made in the following order.
0. Comparative Example (FIG. 1)
1. Embodiment
1.1 Configuration and Workings (FIG. 2 to FIG. 6)
1.2 Modification Examples (FIG. 7 to FIG. 22)
1.3 Effect
2. Other Embodiments

### 0. Comparative Example

In general, an existing stereoscopic image display including a parallax barrier displays a stereoscopic image on a black display surface, which makes some viewers waver where to focus their eyes for stereoscopic viewing and hinders the viewers from recognizing a stereoscopic effect due to convergence. In addition, holograms and the like are still at the laboratory level and necessitate large equipment and are thus not suitable for consumer products in terms of cost.

FIG. 1 illustrates an outline of a display according to a comparative example.

The display according to the comparative example includes a parallax barrier 102 disposed facing a display panel 101. The parallax barrier 102 includes a transmitting part (opening) 121 and a shielding part 122.

PTL 1 (Japanese Unexamined Patent Application Publication No. 2020-46472) proposes a display in which a design layer is stacked on the shielding part 122 of the parallax barrier 102. However, the display described in PTL 1 involves a technique designed to alleviate a sense of discomfort caused by a difference between the position of a display surface of a display panel 101 on which a plane (2D) image 120 is displayed and the position of a surface of the parallax barrier 102 in the depth direction, and not designed to enhance the perception of the stereoscopic image representation.

It is therefore desirable to develop a stereoscopic image display that makes it possible to perform stereoscopic image representation with enhanced stereoscopic perception.

### 1. Embodiment

### 1.1 Configuration and Workings

### <Basic Configuration>

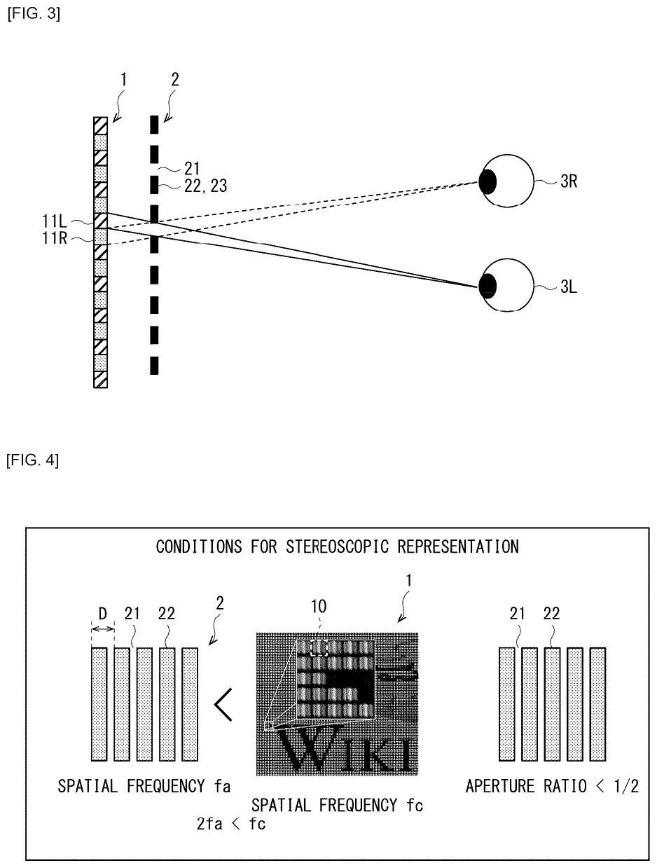

FIG. 2 schematically illustrates an example of a stereoscopic image display 100 according to an embodiment of the disclosure. FIG. 3 illustrates an outline of stereoscopic viewing based on a parallax barrier method.

The stereoscopic image display 100 according to the embodiment includes a display panel 1 including a plurality of pixels 10, and a parallax barrier 2 disposed facing the display panel 1.

The parallax barrier 2 includes a shielding part 22 that shields light emitted from the display panel 1, and a plurality of openings (transmitting part) 21 through which light emitted from the display panel 1 passes. A pattern of design 23 is formed on a surface of the shielding part 22. The structure of the pattern of design 23 will be described in detail later.

The display panel 1 may be a display such as a liquid crystal display (LCD), an organic electroluminescence diode (OLED) display, or a light emitting diode (LED) display, for example. The pixel 10 of the display panel 1 may include a plurality of sub-pixels. The plurality of sub-pixels may include, for example, a red (R) pixel 10R, a green (G) pixel 10G, and a blue (B) pixel 10B. However, the configuration of the pixel 10 is not limited thereto.

As illustrated in FIG. 3, for example, the display panel 1 displays a right-eye image 11R and a left-eye image 11L as a plurality of parallax images forming a stereoscopic image 130. The right-eye image 11R and the left-eye image 11L are alternately arranged separate from each other with a space therebetween over the plurality of pixels 10. The parallax barrier 2 separates the right-eye image 11R from the left-eye image 11L so that the right-eye image 11R reaches a right eye 3R of a viewer and the left-eye image 11L reaches a left eye 3L of the viewer. This allows the viewer to recognize the plurality of parallax images as the stereoscopic image 130 by autostereoscopic viewing.

### <Detailed Configuration of Parallax Barrier 2>

The opening 21 is formed by, for example, forming a fine slit having a size not visible from a viewing distance on a surface of the material itself. On the surface of the shielding part 22 of the parallax barrier 2, a painting or texture having a material feeling is formed as the pattern of design 23. The pattern of design 23 formed on the surface of the shielding part 22 serves as a clue that allows the viewer to perceive the depth of the stereoscopic image representation. As a result, it is possible to display the stereoscopic image 130 with enhanced stereoscopic perception.

The parallax barrier 2 is preferably configured to satisfy the following conditions.
(1) A spatial frequency fb and a contrast of the pattern of design 23 satisfy sufficient requirements for being perceived as depth references.
(2) The structure of the parallax barrier 2 satisfies both a stereoscopic representation functionality and a pattern presentation functionality.

As a result, the stereoscopic image display 100 is able to be placed and display the stereoscopic image 130 in a seamless and natural manner without being distinguished from materials such as walls, floors, and tables. Further, the surface of the material itself of the stereoscopic image display 100 serves as a reference surface of the stereoscopic image 130; therefore, it is easy for the viewer to perceive the sense of frontal protrusion of the stereoscopic image 130.

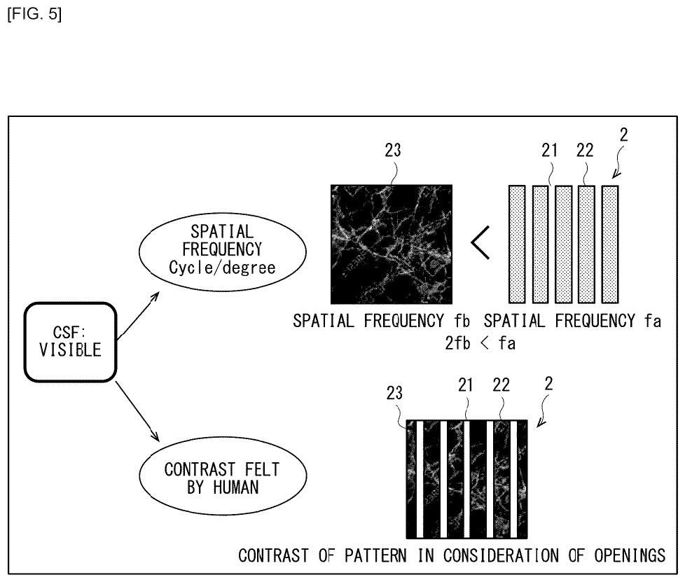

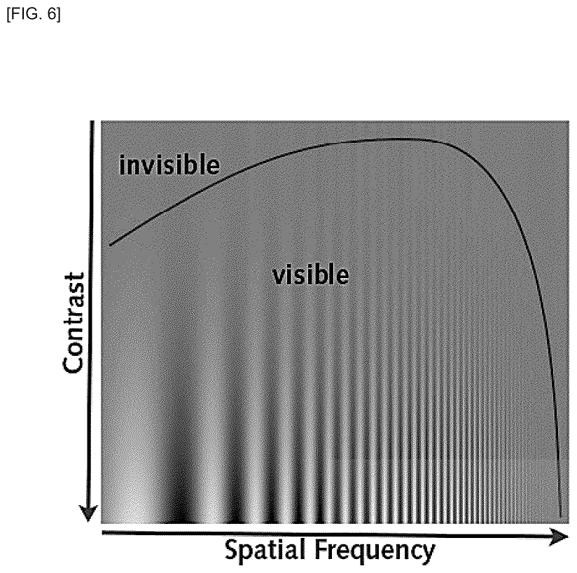

FIG. 4 schematically illustrates exemplary configuration conditions regarding the display panel 1 and the parallax barrier 2 in the stereoscopic image display 100 according to the embodiment. FIG. 5 schematically illustrates exemplary configuration conditions regarding the parallax barrier 2 in the stereoscopic image display 100 according to the embodiment. FIG. 6 illustrates a contrast sensitivity function (CSF).

The stereoscopic image display 100 according to the embodiment is technically characterized in that the parallax barrier 2 the surface of which is decorated with the pattern of design 23 is included, and that the parallax barrier 2 satisfies the requirements for satisfying both an autostereoscopic representation functionality and a functionality of enhancing stereoscopic image perception. In order to satisfy the autostereoscopic representation functionality, it is required that a width D and an aperture ratio of the parallax barrier 2 be in an appropriate relationship with a pixel pitch of the display panel 1. Further, in order to allow the pattern added to the parallax barrier 2 to serve as the clue to the depth, it is required that the width D and the aperture ratio of the parallax barrier 2 be in an appropriate relationship with the spatial frequency fb and the contrast of the added pattern, and as a result, the pattern of design 23 needs to be visible to the viewer. These relationships will now be described.

### <Condition 1 Regarding Spatial Frequency>

When the spatial frequencies of the plurality of openings 21 (the spatial frequency of the parallax barrier 2) are fa and the spatial frequencies of the plurality of pixels 10 (the spatial frequency of the display panel 1) are fc, 2fa<fc is satisfied (FIG. 4). The spatial frequency fa of the parallax barrier 2 is represented by a 1/D, where D is the sum of the width of one shielding part 22 and the width of one opening 21. The spatial frequency fc of the display panel 1 is represented by 1/pixel pitch (sub-pixel pitch). A unit of the spatial frequency is Cycle/degree.

A reason for this is that, in order to present the stereoscopic image 130 to a human, at least two images for viewpoints of the right eye 3R and the left eye 3L need to be presented, and for this purpose, two pixels 10 need to be covered by the width D of the parallax barrier 2.

### <Condition 2 Regarding Spatial Frequency>

When the spatial frequencies of the plurality of openings 21 (the spatial frequency of the parallax barrier 2) are fa and the spatial frequency of the pattern of design 23 is fb, 2fb<fa is satisfied (FIG. 5).

This means that, in order to represent the pattern of design 23 based on the Nyquist frequency, a sampling frequency larger than twice the spatial frequency fb of the pattern of design 23 is required as the spatial frequency fa of the parallax barrier 2 decorated with the pattern of design 23.

### <Condition 3 Regarding Spatial Frequency>

Further, in terms of the visibility of the pattern of design 23, the spatial frequency fb of the pattern of design 23 is set within a visible range (FIG. 5) determined based on the contrast sensitivity function (FIG. 6) in an environment in which the stereoscopic image 130 is observed.

In order to serve as the clue that allows the viewer to perceive the depth, the pattern of design 23 needs to be visible to the viewer. In terms of the visibility, one embodiment is designed based on the contrast sensitivity function. A description of a method of determining the visibility of the pattern based on the contrast sensitivity function will be given later together with a description of the contrast of the pattern.

### <Condition 1 Regarding Aperture Ratio>

The aperture ratio of the parallax barrier 2 is smaller than 1/2 (FIG. 4).

A reason for this is that, in order to present separate images to the right eye 3R and the left eye 3L, more than half of all the pixels of the display panel 1 need to be shielded by the shielding part 22.

### <Condition 2 Regarding Aperture Ratio>

In the environment in which the stereoscopic image 130 is observed, the contrast of the pattern of the design 23 in consideration of the openings 21 is set within the visible range determined based on the contrast sensitivity function (FIG. 5).

When maximum luminance of the pattern of the design 23 is Iₘₐₓ and minimum luminance of the pattern of the design 23 is Iₘᵢₙ, the contrast of the pattern of the design 23 is expressed as follows:

$$Contrast of Pattern : ( {I}_{max} - {I}_{min} ) / ( {I}_{max} + {I}_{min} )$$

On the other hand, when the maximum luminance of the pattern of the design 23 is Iₘₐₓ, the minimum luminance of the pattern of the design 23 is Iₘᵢₙ, the aperture ratio of the parallax barrier 2 is a, and the luminance of the openings 21 is Iₐ, the contrast of the pattern in consideration of the openings 21 is expressed as follows.

$$\frac{{I}_{max} ( 1 - a ) + {I}_{a} a - {I}_{min} ( 1 - a ) - {I}_{a} a}{{I}_{max} ( 1 - a ) + {I}_{a} a + {I}_{min} ( 1 - a ) + {I}_{a} a} = \frac{{I}_{max} ( 1 - a ) - {I}_{min} ( 1 - a )}{{I}_{max} ( 1 - a ) + {I}_{min} ( 1 - a ) + 2 {I}_{a} a} \qquad [ Expression 1 ]$$

This indicates that the pattern of the design 23 the contrast of which is reduced by the openings 21 of the parallax barrier 2 needs to be visible to the viewer.

### <Determination of Visibility Based on Contrast Sensitivity Function>

Finally, a determination of the visibility based on the contrast sensitivity function will be described. As illustrated in FIG. 6, the contrast sensitivity function is two-dimensionally expressed by the spatial frequency and the contrast of the pattern, and an inner side of a certain region is defined as the visible range. It is therefore possible to determine the visibility of the pattern of the design 23 by comparing the spatial frequency fb of the pattern of the design 23 and the contrast of the pattern in consideration of the openings 21 with the graph of the contrast sensitivity function. A definition of the visible range is described in non-patent literature in which the visible range is quantified by an experiment on a subject (https://www.sciencedirect.com/topics/engineering/contrast-sensitivity-function), and it is possible to determine the visibility, based on the literature.

Since the pattern of the design 23 and the contrast of the parallax barrier 2 and the aperture ratio of the parallax barrier 2 are known, a similar determination may be performed by quantifying the spatial frequency fb and the contrast of the pattern of the design 23 by frequency analysis and comparing the result of the quantification with the contrast sensitivity function. Alternatively, a similar determination may be performed by imaging the surface of the parallax barrier 2 by a measuring device such as a camera and quantifying the image obtained as a result of the imaging by frequency analysis.

### 1.2 Modification Examples

### Modification Example 1

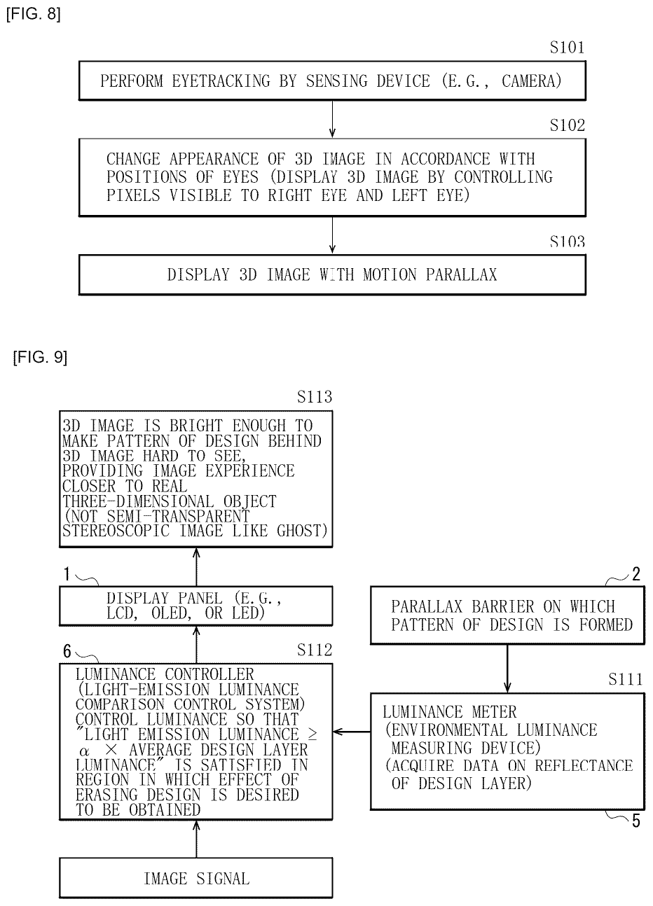

FIGS. 7 and 8 each illustrate an outline of the stereoscopic image display 100 according to Modification Example 1.

As illustrated in FIG. 7, the stereoscopic image display 100 according to Modification Example 1 includes a viewpoint detector 7 that detects a viewpoint position (line-of-sight direction) of the viewer, and a display controller 4 that changes a plurality of parallax images to be displayed on the display panel 1, based on the viewpoint position detected by the viewpoint detector 7.

As illustrated in FIG. 8, the stereoscopic image display 100 according to Modification Example 1 first performs eye tracking using a sensing device (the viewpoint detector 7) such as a camera (Step S101). Next, the display controller 4 performs control to change the appearance of the stereoscopic image 130 in accordance with a change in position of the eyes (i.e., displays the stereoscopic image 130 by controlling the pixels 10 visible to the right eye 3R and the left eye 3L of the viewer) in real time (Step S102). As a result, the stereoscopic image 130 is displayed with motion parallax (Step S103). Adding the motion parallax to the stereoscopic image 130 makes it possible to achieve stereoscopic representation of the stereoscopic image 130 not only stereoscopically visible in the direction of the eyes but also visible with high resolution as if a three-dimensional object is actually present there: for example, an upper surface is visible with high resolution when viewed from above, a right-side surface is visible with high resolution when viewed from the right, and a left-side surface is visible with high resolution when viewed from the left. It is to be noted that the sensing device (the viewpoint detection unit 7) such as a camera may be disposed on a rear surface of the design 23 (the parallax barrier 2) to hide its presence.

### Modification Example 2

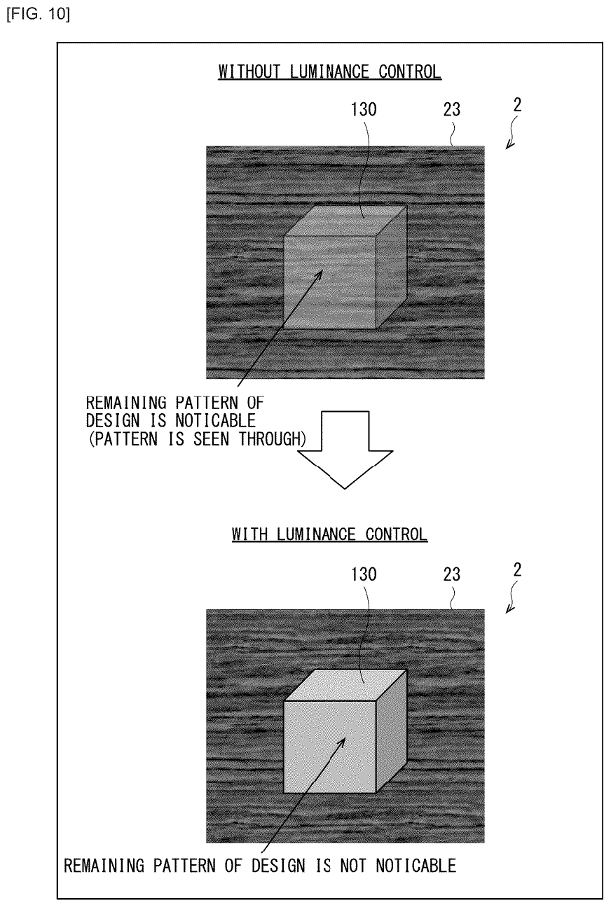

FIGS. 9 and 10 each illustrate an outline of the stereoscopic image display 100 according to Modification Example 2.

As illustrated in FIG. 9, the stereoscopic image display 100 according to Modification Example 2 includes a luminance meter (environmental luminance measuring device) 5 and a luminance controller 6 as a light-emission luminance comparison control system. The luminance meter 5 measures the luminance of a front surface (design layer) of the parallax barrier 2. The luminance controller 6 controls the luminance of the stereoscopic image 130, based on the luminance of the region forming the stereoscopic image 130 on the parallax barrier 2.

When the luminance of the stereoscopic image 130 is low, the pattern of the design 23 on the surface of the parallax barrier 2 is seen through, as illustrated in an upper part of FIG. 10. Therefore, the luminance controller 6 changes the luminance in accordance with the luminance of the design 23 on the surface of the parallax barrier 2 so that the stereoscopic image 130 becomes sufficiently bright. As a result, as illustrated in a lower part of FIG. 10, the pattern of the design 23 behind the stereoscopic image 130 is erased to be less likely to be seen, so that an image experience that is closer to a real three-dimensional object (an image experience that is not a semi-transparent stereoscopic image like a ghost) is achievable (Step S113).

As illustrated in FIG. 8, the stereoscopic image display 100 according to Modification Example 2 first measures the luminance of the front surface (design layer) of the parallax barrier 2 using the luminance meter (environmental luminance measuring device) 5 to acquire a reflectance of the design layer (step S111). To the luminance controller 6, an image signal that is a source of the stereoscopic image 130 and data on the reflectance of the design layer from the luminance meter 5 are inputted. The luminance controller 6 controls the luminance of the stereoscopic image 130 (i.e., controls the luminance of the parallax images displayed on the display panel 1) so that “light-emission luminance>α×average design layer luminance” is satisfied in a region (the region forming the stereoscopic image 130) in which an effect of erasing the design 23 is desired to be obtained (Step S112). It is to be noted that the value of the coefficient α is, for example, α=6 in a case where the pattern of the design 23 is a general pattern such as woodgrain, marble, or metal.

It is to be noted that the light-emission luminance comparison control system is not necessarily incorporated in the stereoscopic image display 100 as a component, and alternatively, may achieve light-emission luminance satisfying a conditional expression obtained by sensory evaluation, measurement instrument, or the like in advance.

### Modification Example 3

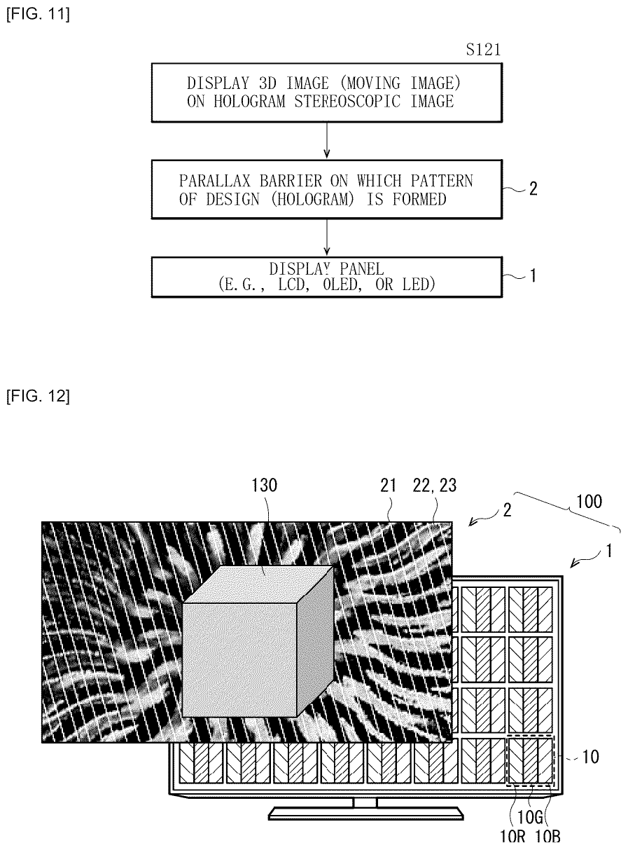

FIGS. 11 and 12 each illustrate an outline of the stereoscopic image display 100 according to Modification Example 3.

In the stereoscopic image display 100 according to Modification Example 3, the pattern of the design 23 on the parallax barrier 2 is formed by a hologram sheet. For example, used as the parallax barrier 2 is a hologram sheet on which a three-dimensional object is drawn and that undergone fine slit processing. This enables representation in which a stereoscopic moving image as the stereoscopic image 130 is superimposed on the hologram stereoscopic image (Step S121).

### Modification Example 4

As the stereoscopic image display 100 according to Modification Example 4, an example is described in which the design 23 on the front surface of the parallax barrier 2 is devised to control an action on human perception, such as enhancing depth perception.

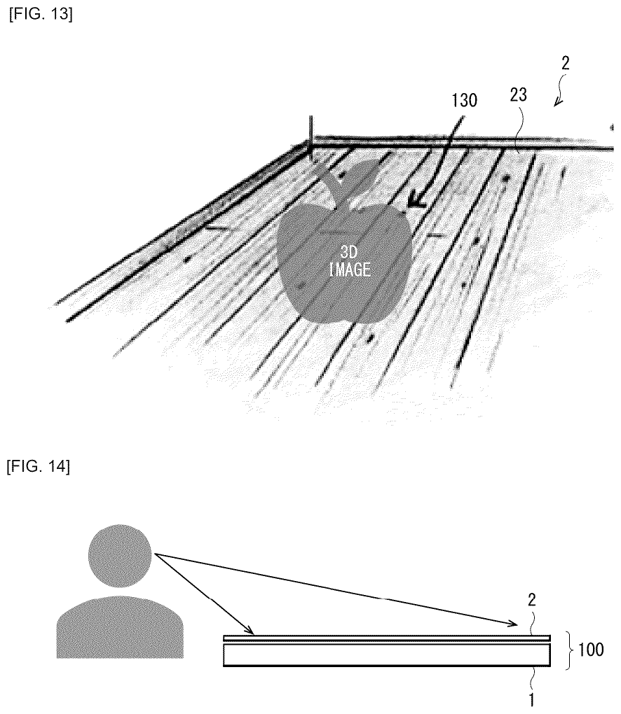

FIG. 13 illustrates a first configuration example of the stereoscopic image display 100 according to Modification Example 4.

As the pattern of the design 23 on the surface of the parallax barrier 2, a perspective pattern that enhances depth perception may be formed. For example, in a case where the display is placed flat and viewed obliquely in order to enhance the depth perception, the pattern of the design 23 is added which has a perspective view that makes the depth easily perceptible (the perspective pattern). Specifically, in an example case where a woodgrain pattern is used as the pattern of the design 23, not only a pattern of a curve such as an annual ring but also a straight line extending from the front to the back, such as a joint between plates may be added. This adds a clue to the depth. As a result, the perspective view becomes the clue to the depth, and the depth perception felt by the viewer is enhanced.

FIG. 14 illustrates a second configuration example of the stereoscopic image display 100 according to Modification Example 4.

The pattern of the design 23 on the parallax barrier 2 may be formed so that the spatial frequency fb and the contrast change depending on a planar position.

When the stereoscopic image display 100 with a uniform pattern made over the entire surface is used in a flat state, the visibility of the contrast sensitivity function changes depending on a distance from the viewer. Accordingly, for example, the pattern of the design 23 may be changed to be different between an area that is likely to be far from the viewer and an area that is likely to be close to the viewer.

For example, when the stereoscopic image display 100 is placed flat in use, the distance from the viewer to a front portion of the stereoscopic image display 100 and the distance from the viewer to a back portion of the stereoscopic image display 100 are different from each other. At this time, if the pattern of the design 23 on the parallax barrier 2 is uniform over the entire surface, an apparent spatial frequency of the pattern of the design 23 is different between the front portion and the back portion, which can change the visibility of the pattern of the design 23. To address this problem, the spatial frequency fb and the contrast of the pattern of the design 23 are intentionally changed to be different between the front portion and the back portion of the stereoscopic image display 100. This makes it possible to make the viewer feel the pattern on the entire surface of the stereoscopic image display 100. Accordingly, it is possible to enhance the visibility of the pattern of the design 23 in the entire area regardless of the distance from the viewer.

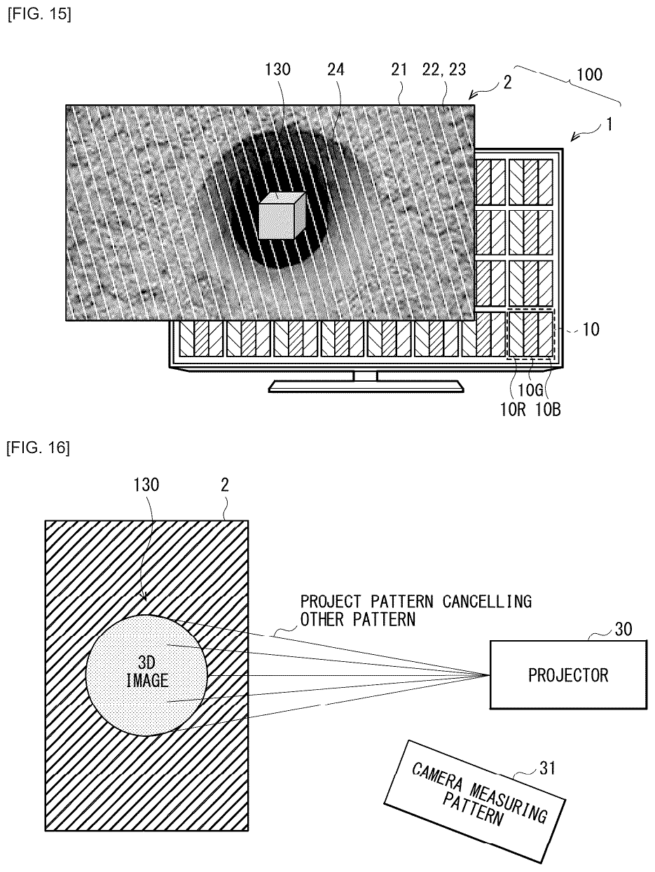

FIG. 15 illustrates a third configuration example of the stereoscopic image display 100 according to Modification Example 4.

The pattern of the design 23 on the parallax barrier 2 may include a curved surface pattern 24 that allows for pseudo perception of a curved surface. It is difficult to form the display panel 1 and the parallax barrier 2 each having a curved surface and configured to perform accurate stereoscopic image representation. Accordingly, a pictorial uneven pattern may be added as the curved surface pattern 24 to the pattern of the design 23, thereby allowing for pseudo perception of the curved surface of the display. As a result, it is possible to display the stereoscopic image 130 on the design 23 of a pseudo curved shape using optical illusion. As a result, it is possible to achieve a view in which a three-dimensional object is present in a pictorial portion appearing to be recessed, for example.

### Modification Example 5

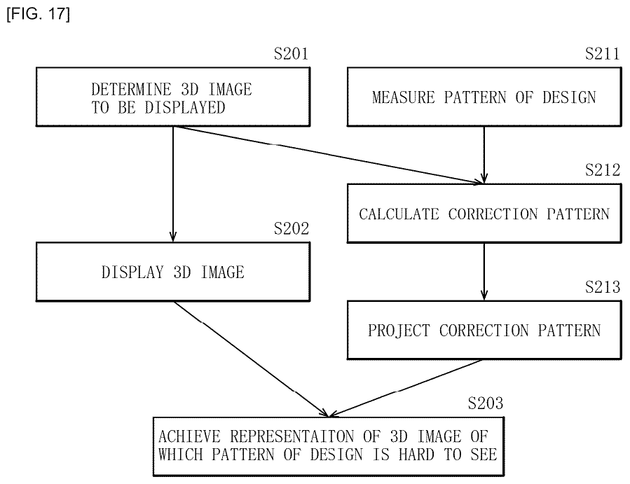

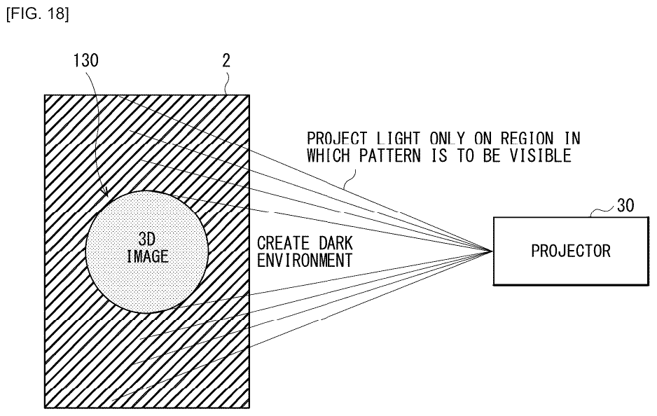

FIGS. 16 and 17 each illustrate an outline of the stereoscopic image display 100 according to Modification Example 5.

As illustrated in FIG. 16, the stereoscopic image display 100 according to Modification Example 5 includes a projector (projection device) 30 that projects a pattern that cancels the pattern of the design 23 onto the region forming the stereoscopic image 130 on the parallax barrier 2.

When the luminance of the stereoscopic image 130 to be displayed by the stereoscopic image display 100 is low, the pattern of the design 23 may be seen through in the region forming the stereoscopic image 130 on the parallax barrier 2, which can weaken the stereoscopic perception of the image. Even when the stereoscopic image 130 is displayed so as to protrude from the surface of the parallax barrier 2, it is difficult for the viewer to stereoscopically perceive the protrusion of the stereoscopic image 130 due to the pattern of the design 23 that is seen through the stereoscopic image 130.

In the stereoscopic image display 100 according to Modification Example 5, the projector (projection device) 30 projects the pattern that cancels the pattern of the design 23 only onto the region forming the stereoscopic image 130 on the parallax barrier 2. As a result, the pattern of the design 23 in the region forming the stereoscopic image 130 becomes hard to see, and accurate stereoscopic perception of the stereoscopic image 130 is achieved.

In the stereoscopic image display 100 according to Modification Example 5, as illustrated in FIG. 17, when the stereoscopic image 130 to be displayed is determined (Step S201), the stereoscopic image 130 is displayed (Step S202). In parallel with this, the pattern of the design 23 is measured by the camera 31 that measures the pattern of the design 23 (Step S211). The projector (projection device) 30 calculates a correction pattern for canceling the pattern of the design 23, based on the measurement of the pattern of the design 23 (Step S212), and projects the correction pattern onto the region forming the stereoscopic image 130 (Step S213). In this way, it is possible to achieve representation of the spectroscopic image the pattern of the design 23 of which is hard to see (Step S203).

### Modification Example 6

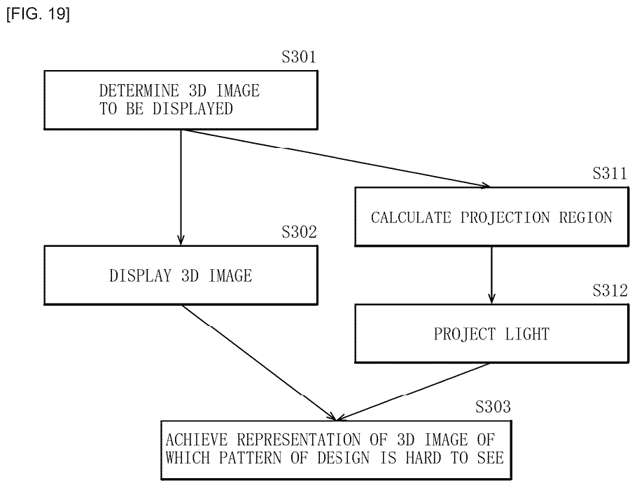

FIGS. 18 and 19 each illustrate an outline of the stereoscopic image display 100 according to Modification Example 6.

As illustrated in FIG. 18, the stereoscopic image display 100 according to Modification Example 6 includes the projector (projection device) 30 that projects a pattern that brightly illuminates a region other than the region forming the stereoscopic image 130 on the parallax barrier 2.

In the stereoscopic image display 100 according to Modification Example 6, the region other than the region forming the stereoscopic image 130 on the parallax barrier 2 is darkened to create an environment that is illuminated only by ambient light and in which the pattern of the design 23 is hardly visible. In this state, the projector 30 brightly illuminates only a region where the design 23 is desired to be visible (does not illuminate the region forming the stereoscopic image 130). As a result, the control of making the design 23 hard to see in the region forming the stereoscopic image 130 and making the pattern of the design 23 easy to see in the other region. In other words, the pattern of the design 23 is cancelled by subtraction. As a result, the pattern of the design 23 in the region forming the stereoscopic image 130 becomes hard to see, and accurate stereoscopic perception of the stereoscopic image 130 is achieved.

In the stereoscopic image display 100 according to Modification Example 6, as illustrated in FIG. 19, when the stereoscopic image 130 to be displayed is determined (Step S301), the stereoscopic image 130 is displayed (Step S302). In parallel with this, the projector (projection device) 30 calculates a projection region (Step S311), and a pattern for brightly illuminating the calculated projection region is projected (Step S312). In this way, it is possible to achieve representation of the stereoscopic image the pattern of the design 23 of which is hard to see (Step S303).

### Modification Example 7

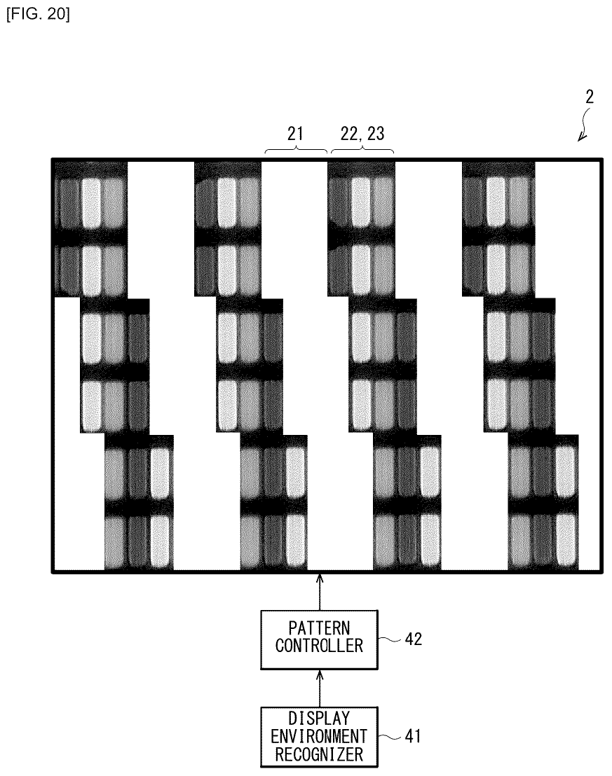

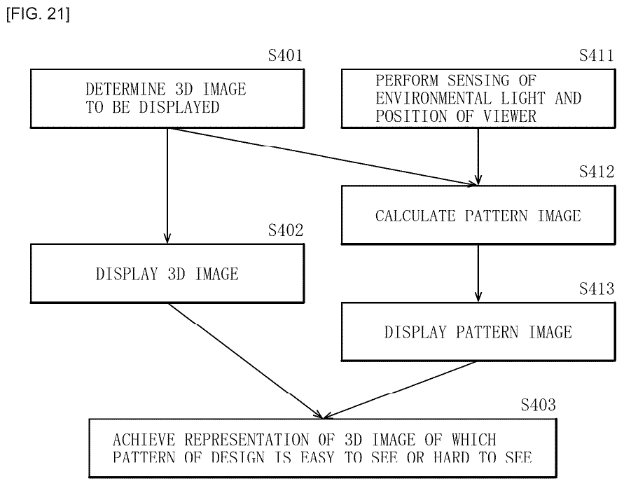

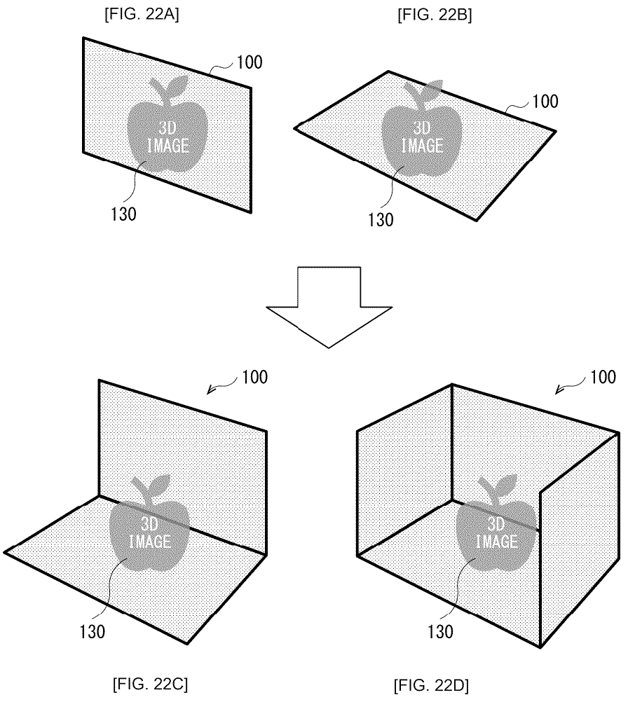

FIGS. 20 and 21 each illustrate an outline of the stereoscopic image display 100 according to Modification Example 7.

As illustrated in FIG. 20, the stereoscopic image display 100 according to Modification Example 7 is a display device configured to change the pattern of the design 23 on the parallax barrier 2. The display device configured to change the pattern of the design 23 may be a device configured to actively control the pattern, such as an OLED display or electronic paper. The stereoscopic image display 100 according to Modification Example 7 further includes a display environment recognizer 41 and a pattern controller 42. The pattern controller 42 performs control to change the pattern of the design 23 to be formed by the display device to the pattern of the design 23 according to an environment recognized by the display environment recognizer 41.

If the pattern of the design 23 on the parallax barrier 2 is fixed, for example, the following problems arise.
(1) The visibility of the pattern of the design 23 changes with a change in distance between the viewer and the stereoscopic image display 100.
(2) The visibility of the pattern of the design 23 changes with a change in ambient light.
(3) The pattern of the design 23 is seen through and covers the stereoscopic image 130, depending on the color and luminance of the stereoscopic image 130 to be displayed.
(4) The pattern of the design 23 is not changeable for each application.

In order to solve these problems, the display device configured to actively change the pattern of the design 23 is used as the parallax barrier 2. Specifically, a device including pixels formed in the shielding part 22 of the parallax barrier 2 is used. No pixel may be formed in the transmitting part (opening) 21. The pattern controller 42 appropriately controls the pattern in accordance with the conditions (1) to (4). By controlling the visibility of the pattern according to the situation, it is possible to make the pattern easy to see and maintain an effect as a clue to the depth, or conversely, it is possible to make the pattern hard to see and make the stereoscopic image 130 clearly visible.

For example, as an example of the condition (1) described above, in a case where the distance from the viewer becomes long and the pattern of the design 23 becomes hard to see accordingly, the pattern controller 42 performs control of increasing the contrast of the pattern of the design 23.

In an example of the condition (2) described above in which the environment becomes bright and the pattern of the design 23 becomes hard to see, the pattern controller 42 performs control of increasing the contrast and the luminance of the pattern of the design 23.

In an example of the condition (3) described above in which the pattern of the design 23 is seen through, the pattern controller 42 performs control of reducing the contrast and the luminance of the pattern of the design 23.

In an example of the condition (4) described above in which wallpaper of a wall on which the stereoscopic image display 100 is installed is changed, the pattern controller 42 performs control of changing the pattern of the design 23 to that matching the new wallpaper.

In the stereoscopic image display 100 according to Modification Example 7, as illustrated in FIG. 21, when the stereoscopic image 130 to be displayed is determined (Step S401), the stereoscopic image 130 is displayed (Step S402). In parallel with this, the display environment recognizer 41 senses the ambient light and the position of the viewer (Step S411). The pattern controller 42 calculates the pattern of the design 23 (pattern image), based on a result of sensing by the display environment recognizer 41 (Step S412), and displays the pattern image on the display device configured to change the pattern of the design 23 (Step S413). In this way, it is possible to achieve representation of the stereoscopic image the pattern of the design 23 of which is hard to see or easy to see (Step S403).

### Modification Example 8

FIG. 22 illustrates an outline of the stereoscopic image display 100 according to Modification Example 8.

In Modification Example 8, a non-planar stereoscopic image display 100 is provided by assembling a plurality of stereoscopic image displays 100 each including the display panel 1 and the parallax barrier 2 as described above.

It is possible to configure the non-planar stereoscopic image display 100 with enhanced depth perception by assembling the plurality of stereoscopic image displays 100. For example, an L-shaped stereoscopic image display 100 (Part (C) of FIG. 22) or a box-shaped stereoscopic image display 100 (Part (D) of FIG. 22) may be configured. Compared with a simple planar stereoscopic image display 100 (Parts (A) and (B) of FIG. 22), the shape of the stereoscopic image display 100 serves as the clue to the depth, which makes it possible to enhance the stereoscopic perception by the viewer. The L-shaped or the box-shaped stereoscopic image display 100 has a higher functionality as the clue to the depth than the simple planar stereoscopic image display 100.

### 1.3 Effect

As described above, it is possible for the stereoscopic image display 100 according to the embodiment to perform stereoscopic image representation with enhanced stereoscopic perception. An existing stereoscopic image display of a parallax barrier type has a difficulty in making the viewer feel a stereoscopic effect due to congestion, whereas the stereoscopic image display 100 according to the embodiment allows the pattern of the design 23 formed on the surface of the parallax barrier 2 based on the contrast sensitivity function to serve as the clue to the depth of the stereoscopic image for the viewer. In this way, it is possible to achieve representation of the stereoscopic image 130 with enhanced stereoscopic perception.

It is to be noted that the effects described herein are merely examples and are not limited, and other effects may be obtained. The same applies to the effects of the other embodiments.

### 2. Other Embodiments

The technology according to the disclosure is not limited to the description of the above-described embodiment, and various modifications may be made.

For example, the present technology may have the following configuration.

According to the present technology having the following configuration, the spatial frequency of the pattern of the design formed on the surface of the parallax barrier is set within the visible range determined based on the contrast sensitivity function in the environment in which a stereoscopic image is observed. In this way, it is possible to achieve representation of a stereoscopic image with enhanced stereoscopic perception.

(1)

A stereoscopic image display including:
a display panel including a plurality of pixels and displaying a plurality of parallax images forming a stereoscopic image;
a parallax barrier disposed facing the display panel and including a shielding part having a surface on which a pattern of design is formed and a plurality of openings through which light emitted from the display panel passes, in which,
in an environment in which the stereoscopic image is observed, a spatial frequency of the pattern of design is set within a visible range determined based on a contrast sensitivity function.
   (2)

The stereoscopic image display according to (1), in which, when spatial frequencies of the plurality of openings are fa and the spatial frequency of the pattern of design is fb, 2fb<fa is satisfied.

(3)

The stereoscopic image display according to (1) or (2), in which, in the environment in which the stereoscopic image is observed, a contrast of the pattern of design in consideration of the openings is set within the visible range determined based on the contrast sensitivity function.

(4)

The stereoscopic image display according to any one of (1) to (3), in which, when spatial frequencies of the plurality of openings are fa and spatial frequencies of the plurality of pixels are fc, 2fa<fc is satisfied.

(5)

The stereoscopic image display according to any one of (1) to (4), in which an aperture ratio of the parallax barrier is less than 1/2.

(6)

The stereoscopic image display according to any one of (1) to (5), in which a perspective pattern that enhances depth perception is formed as the pattern of design.

(7)

The stereoscopic image display according to any one of (1) to (6), in which
the parallax barrier comprises a display device configured to change the pattern of design, and
the stereoscopic image display further includes a pattern controller that changes the pattern of design formed by the display device to a pattern according to an environment.
   (8)

The stereoscopic image display according to any one of (1) to (7), including
a plurality of stereoscopic image displays each including the display panel and the parallax barrier, in which
a non-planar stereoscopic image display is formed by assembling the plurality of stereoscopic image displays.
   (9)

The stereoscopic image display according to any one of (1) to (8), further including:
a viewpoint detector detecting a viewpoint position of a viewer; and
a display controller changing the plurality of parallax images to be displayed on the display panel, based on the viewpoint position detected by the viewpoint detector.
   (10)

The stereoscopic image display according to any one of (1) to (9), further including a luminance controller controlling luminance of the stereoscopic image, based on luminance of a region forming the stereoscopic image on the parallax barrier.

(11)

The stereoscopic image display according to any one of (1) to (6) or any one of (8) to (10), in which the pattern of design of the parallax barrier is formed of a hologram sheet.

(12)

The stereoscopic image display according to any one of (1) to (11), in which the pattern of design of the parallax barrier is formed to cause the spatial frequency and a contrast to change depending on a planar position.

(13)

The stereoscopic image display according to any one of (1) to (12), in which the pattern of design of the parallax barrier includes a pattern that allows for pseudo perception of a curved surface.

(14)

The stereoscopic image display according to any one of (1) to (13), further including a projection device projecting a pattern that cancels the pattern of design on a region forming the stereoscopic image on the parallax barrier.

(15)

The stereoscopic image display according to any one of (1) to (13), further including a projection device projecting a pattern that brightly illuminates a region other than a region forming the stereoscopic image on the parallax barrier.

The present application claims the benefits of Japanese Priority Patent Application No. 2022-178715 filed with the Japan Patent Office on Nov. 8, 2022, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A stereoscopic image display comprising:
a display panel including a plurality of pixels and displaying a plurality of parallax images forming a stereoscopic image;
a parallax barrier disposed facing the display panel and including a shielding part having a surface on which a pattern of design is formed and a plurality of openings through which light emitted from the display panel passes, wherein,
in an environment in which the stereoscopic image is observed, a spatial frequency of the pattern of design is set within a visible range determined based on a contrast sensitivity function.

2. The stereoscopic image display according to claim 1, wherein, when spatial frequencies of the plurality of openings are fa and the spatial frequency of the pattern of design is fb, 2fb<fa is satisfied.

3. The stereoscopic image display according to claim 1, wherein, in the environment in which the stereoscopic image is observed, a contrast of the pattern of design in consideration of the openings is set within the visible range determined based on the contrast sensitivity function.

4. The stereoscopic image display according to claim 1, wherein, when spatial frequencies of the plurality of openings are fa and spatial frequencies of the plurality of pixels are fc, 2fa<fc is satisfied.

5. The stereoscopic image display according to claim 1, wherein an aperture ratio of the parallax barrier is less than 1/2.

6. The stereoscopic image display according to claim 1, wherein a perspective pattern that enhances depth perception is formed as the pattern of design.

7. The stereoscopic image display according to claim 1, wherein
the parallax barrier comprises a display device configured to change the pattern of design, and
the stereoscopic image display further comprises a pattern controller that changes the pattern of design formed by the display device to a pattern according to an environment.

8. The stereoscopic image display according to claim 1, comprising
a plurality of stereoscopic image displays each including the display panel and the parallax barrier, wherein
a non-planar stereoscopic image display is formed by assembling the plurality of stereoscopic image displays.

9. The stereoscopic image display according to claim 1, further comprising:
a viewpoint detector detecting a viewpoint position of a viewer; and
a display controller changing the plurality of parallax images to be displayed on the display panel, based on the viewpoint position detected by the viewpoint detector.

10. The stereoscopic image display according to claim 1, further comprising a luminance controller controlling luminance of the stereoscopic image, based on luminance of a region forming the stereoscopic image on the parallax barrier.

11. The stereoscopic image display according to claim 1, wherein the pattern of design of the parallax barrier is formed of a hologram sheet.

12. The stereoscopic image display according to claim 1, wherein the pattern of design of the parallax barrier is formed to cause the spatial frequency and a contrast to change depending on a planar position.

13. The stereoscopic image display according to claim 1, wherein the pattern of design of the parallax barrier includes a pattern that allows for pseudo perception of a curved surface.

14. The stereoscopic image display according to claim 1, further comprising a projection device projecting a pattern that cancels the pattern of design on a region forming the stereoscopic image on the parallax barrier.

15. The stereoscopic image display according to claim 1, further comprising a projection device projecting a pattern that brightly illuminates a region other than a region forming the stereoscopic image on the parallax barrier.
